(19) United States
(12) Patent Application Publication
(10) Pub. No.: US 2004/0175006 A1
(43) Pub. Date: Sep. 9, 2004

(54) Microphone array, method and apparatus for forming constant directivity beams using the same, and method and apparatus for estimating acoustic source direction using the same

(75) Inventors: Jaywoo Kim, Gyeonggi-do (KR); Dong-geon Kong, Busan-si (KR); Chang-kyu Choi, Seoul (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/793,270

(22) Filed: Mar. 5, 2004

(30) Foreign Application Priority Data
Mar. 6, 2003 (KR) 10-2003-14006

(51) Int. Cl. H04R 3/00

(52) U.S. Cl. 381/92; 381/122

(57) ABSTRACT

A microphone array, beam forming method and apparatus using the microphone array, and a method and apparatus for estimating an acoustic source direction using the microphone array are provided. The apparatus for forming constant directivity beams comprising: a microphone array, which is comprised of first through n-th microphone sub-arrays, wherein each of the microphone sub-arrays comprises: a first microphone placed at a predetermined location on a flat plate, which commonly belongs to each of the microphone sub-arrays; and second and third microphones placed at locations perpendicularly spaced by a predetermined segment from a straight line connecting the first microphone and the center of the flat plate, the predetermined segment being determined depending on a target frequency allotted to reach of the microphone sub-arrays, a beam formation unit receiving voice signals output from the first through n-th microphone sub-arrays and generating a beam for each of the first through n-th microphone sub-arrays; a filtering unit filtering the beams output from the beam formation unit; and an adding unit adding the filtered signals output from the filtering unit.

### BACKGROUND OF THE INVENTION

This application claims the priority of Korean Patent Application No. 2003-14006, filed on Mar. 6, 2003, in the Korean Intellectual Property Office, the disclosure of which is incorporated herein in its entirety by reference.

1. Field of the Invention

The present invention relates to audio technology using a microphone array, and more particularly, to a microphone array, a method and apparatus for forming constant directivity beams using the same, and a method and apparatus for estimating an acoustic source direction using the same.

2. Description of the Related Art

Voice-related techniques, such as hand-free communications, video conferences, or voice recognition, need a robust voice capture system appropriate for an environment where noise and reverberations exist. Recently, a microphone array adopting a beam forming method capable of increasing a signal-to-noise ratio by preventing noise and reverberations from affecting desired voice signals has been widely used to establish such a robust voice capture system.

The directivity pattern of a microphone array where signals output from a predetermined number of microphones are summed up is dependent on frequency. In general, the directivity pattern of a microphone array is mainly affected by the effective length of the microphone array and the wavelength of an acoustic signal having a specific frequency. For example, the microphone array has low directivity at a low frequency accompanying a longer wavelength than the aperture size of the microphone array and has constant directivity at a high frequency accompanying a shorter wavelength than the aperture size of the microphone array. In other words, the directivity level of the microphone array varies with respect to frequency. A shortest wavelength where the microphone array can provide constant directivity is dependent on the entire length of the microphone array, and a highest frequency having no side lobe that generally has a considerable influence on the directivity pattern of the microphone array is dependent on a distance between microphones constituting the microphone array. Accordingly, the number of microphones and the distance between the microphones are determined in consideration of a required frequency range capable of providing any given degree of directivity.

In the meantime, microphone arrays for forming beams are classified into linear and non-linear arrays or uniform and non-uniform arrays. Here, the uniform arrays are less welcomed than the non-uniform arrays because even though the uniform arrays are easy to manufacture and analyze, their directivity pattern varies with respect to frequency. Therefore, in recent years, various efforts have been made to provide a constant level of directivity using a non-uniform array structure rather than a uniform array structure.

Beam forming techniques using various microphone arrays having different geometrical structures have already been disclosed in U.S. Pat. Nos. 5,657,393, 7,737,485, 6,339,758, and 6,449,586. In particular, various constant directivity beam forming techniques also have been presented in many articles and books, such as “Microphone Arrays Signal Processing Techniques and Applications” written by Ward et al. (Springer, page 3-17: constant directivity beam-forming).

In general, a voice recognizer generates an acoustic model in a close-talk environment and expects signals having the same characteristics to apply thereinto via each frequency channel. Here, that the signals have the same characteristics indicates that among the signals, those coming from a target source have been amplified by the same amount and those coming from a noise source have been attenuated by the same amount. However, in the case of combining a voice recognizer with a microphone array, the gain characteristics of a main lobe may vary especially when different frequency levels are brought about by the same incident angle, if microphones in the microphone array are arranged a constant distance apart. In addition, in a case where a moving robot is a voice capture system, such as a microphone array, or the target source is moving, a look direction error may occur, which results in a plummeting voice recognition rate. In addition, in a far-talk voice recognition environment, low frequency noise is more likely to infiltrate into desired acoustic signals, which also brings about a decrease in voice recognition rate.

### SUMMARY OF THE INVENTION

The present invention provides a microphone array capable of forming constant directivity beams having a low side lobe and a main lobe whose characteristics are not affected by frequency.

The present invention also provides beam forming method and apparatus using the microphone array. The method and apparatus are capable of robustly capturing a target signal irrespective of whether or not an error occurs during estimating a target source direction.

The present invention also provides a method and apparatus for precisely estimating an acoustic source direction using the microphone array.

In one aspect, the present invention provides a microphone array comprising: first through n-th microphone sub-arrays, wherein each of the microphone sub-arrays comprises: a first microphone placed at a predetermined location on a flat plate, which commonly belongs to each of the microphone sub-arrays; and second and third microphones placed at locations perpendicularly spaced by a predetermined segment from a straight line connecting the first microphone and the center of the flat plate, the predetermined segment being determined depending on a target frequency allotted to reach of the microphone sub-arrays.

In another aspect, the present invention provides an apparatus for forming constant directivity beams comprising: a microphone array, which is comprised of first through n-th microphone sub-arrays, wherein each of the microphone sub-arrays comprises: a first microphone placed at a predetermined location on a flat plate, which commonly belongs to each of the microphone sub-arrays; and second and third microphones placed at locations perpendicularly spaced by a predetermined segment from a straight line connecting the first microphone and the center of the flat plate, the predetermined segment being determined depending on a target frequency allotted to reach of the microphone sub-arrays, a beam formation unit receiving voice signals output from the first through n-th microphone sub-arrays and generating a beam for each of the first through n-th microphone sub-arrays; a filtering unit filtering the beams output from the beam formation unit; and an adding unit adding the filtered signals output from the filtering unit.

In still another aspect, the present invention provides a method of forming constant directivity beams (a) placing a microphone array, which is comprised of first through n-th microphone sub-arrays, wherein each of the microphone sub-arrays comprises: a first microphone placed at a predetermined location on a flat plate, which commonly belongs to each of the microphone sub-arrays; and second and third microphones placed at locations perpendicularly spaced by a predetermined segment from a straight line connecting the first microphone and the center of the flat plate, the predetermined segment being determined depending on a target frequency allotted to reach of the microphone sub-arrays, the method comprising (a) forming a beam for each of the first through n-th microphone sub-arrays by receiving voice signals output from the first through n-th microphone sub-arrays; (b) performing one of low pass filtering, band pass filtering, and high pass filtering on the beams generated in step (a) depending on their corresponding target frequencies; and (c) adding the results of the filtering performed in step (b).

In still another aspect, the present invention provides an apparatus for estimating an acoustic source direction, comprising a microphone array, which is comprised of first through n-th microphone sub-arrays, wherein each of the microphone sub-arrays comprises: a first microphone placed at a predetermined location on a flat plate, which commonly belongs to each of the microphone sub-arrays; and second and third microphones placed at locations perpendicularly spaced by a predetermined segment from a straight line connecting the first microphone and the center of the flat plate, the predetermined segment being determined depending on a target frequency allotted to reach of the microphone sub-arrays, a high-speed Fourier transform unit converting voice signals output from (2n+1) microphones into frequency-domain voice signals by performing high-speed Fourier transform on the voice signals; and an acoustic source direction detection means detecting a peak value over all frequency ranges in a spatial spectrum provided for each frequency bin of each of the frequency-domain voice signals provided by the high-speed Fourier transform unit and then determining a direction corresponding to the detected peak value as an estimated acoustic source direction.

In still another aspect, the present invention provides a method for estimating an acoustic source direction, (a) placing a microphone array, which is comprised of first through n-th microphone sub-arrays, wherein each of the microphone sub-arrays comprises: a first microphone placed at a predetermined location on a flat plate, which commonly belongs to each of the microphone sub-arrays; and second and third microphones placed at locations perpendicularly spaced by a predetermined segment from a straight line connecting the first microphone and the center of the flat plate, the predetermined segment being determined depending on a target frequency allotted to reach of the microphone sub-arrays, the method comprising (a) converting voice signals output from (2n+1) microphones into frequency-domain voice signals by performing high-speed Fourier transform on the voice signals; and (b) detecting a peak value over all frequency ranges in a spatial spectrum provided for each frequency bin of each of the frequency-domain voice signals obtained in step (a) and then determining a direction corresponding to the detected peak value as an estimated acoustic source direction.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are diagrams illustrating the structure of a microphone array according to a preferred embodiment of the present invention;

FIG. 2 is a block diagram of a beam forming apparatus according to a first embodiment of the present invention;

FIG. 3 is a block diagram of a beam forming apparatus according to a second embodiment of the present invention;

FIG. 4 is a block diagram of an apparatus for estimating an acoustic source direction according to a preferred embodiment of the present invention;

FIGS. 5A and 5B are diagrams illustrating a microphone array according to a preferred embodiment and a conventional microphone array, respectively, for comparing a beam forming method according to a preferred embodiment of the present invention with a conventional beam forming method; and

FIGS. 6A through 6F are diagrams showing beam patterns obtained at different frequency ranges adopting a beam forming method using the microphone array shown in FIG. 5A according to a preferred embodiment of the present invention and beam patterns obtained at different frequency ranges adopting a conventional beam forming method using the microphone array shown in FIG. 5B.

### DETAILED DESCRIPTION OF THE INVENTION

Hereinafter, the present invention will be described in greater detail with reference to the accompanying drawings in which preferred embodiments of the invention are shown.

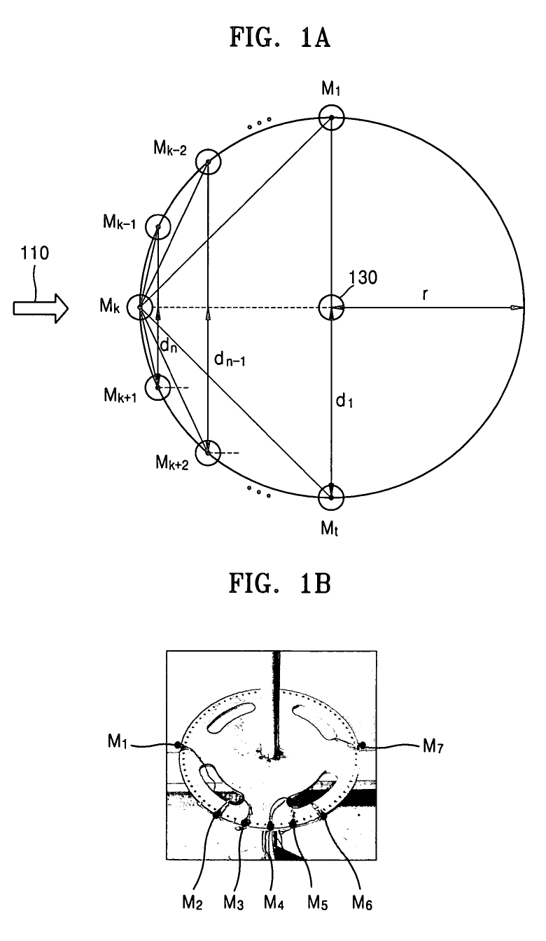

FIG. 1A is a diagram illustrating the structure of a microphone array according to a preferred embodiment of the present invention, and FIG. 1B shows a microphone array comprised of 7 microphones and 3 microphone sub-arrays. In FIGS. 1A and 1B, a circular microphone array is shown. However, any type of microphone array that can satisfy Equation (1), which will be presented in this disclosure later, can also be used. Referring to FIG. 1A, a microphone array according to a preferred embodiment of the present invention is comprised of n sub-arrays arranged on a flat plate, for example, a semicircular plate. The number (n) of sub-arrays is determined to be the same as the number (n) of frequency channels of an acoustic model used in a voice recognizer coupled with the microphone array. In other words, the number (n) of sub-arrays and the number of microphones M₁, . . . , Mₜ(t=2n+1) constituting the microphone array vary with respect to the number (n) of frequency channels of the acoustic model. Here, the microphones M₁, . . . , Mₜ may be omidirectional microphones, unidirectional microphones, or bi-directional microphones. In FIG. 1A, reference numeral 110 represents a target source direction, i.e., an acoustic source direction. The target source direction 110 can be estimated by performing sound source localization in advance but this estimation can have an error due to various reasons such as the moving target, reverberation, and the noise source located near the target source.

Each microphone sub-array is comprised of three microphones including a microphone Mₖ. For example, microphones M₁, Mₖ, and Mₜ constitute a first microphone sub-array, microphones Mₖ₋₂, Mₖ, and Mₖ₊₂ constitute an (n−1)-th microphone sub-array, and Mₖ₋₁, Mₖ, and Mₖ₊₁ constitute an n-th microphone sub-array. Each of the microphone sub-arrays is triangular-shaped having the microphone Mₖ as its vertex and a straight line connecting two other microphones as the baseline. A target frequency fᵢ (i is a number between 1 and n) is allotted to each of microphone sub-arrays depending on each frequency channel of the acoustic model. Once the target frequency fᵢ is determined, the locations of microphones constituting the i-th microphone sub-arrays except for the location of the microphone Mₖ are determined. The locations of two microphones other than the microphone Mₖ constituting each of the microphone sub-arrays can be determined using Equation (1) below.

$${d}_{i} = \frac{c}{2 {f}_{i}} \\ ( i = 1 , … , n ) \qquad ( 1 )$$

In Equation (1), c indicates the velocity of sound in the air, i.e., 343 m/sec, and fᵢ indicates the target frequency allotted to the i-th microphone sub-array (i is a number between 1 and n). For example, fₗ represents the lowest frequency among frequencies provided by all the frequency channels of the acoustic model, and fₙ represents the highest one among the frequencies. In addition, dᵢ represents a predetermined segment extending from a straight line connecting between the microphone Mₖ and a central axis 130 to the edge of the semicircular plate in perpendicular to the straight line. The two microphones constituting the i-th microphone sub-array along with the microphone Mₖ are respectively located at intersections of an extended line of the segment dᵢ and the circumference of the semicircular plate.

In the case of using the n triangular-shaped microphone sub-arrays having different lengths of baselines depending on their corresponding target frequencies allotted by the frequency channels of the acoustic model, the possibility of a side lobe occurring near each of the target frequencies decreases, and it is possible to generate a beam pattern having a main lobe of a constant characteristics, i.e., a constant shape, irrespective of which frequency band each of the target frequencies comes from.

Referring to FIG. 1B, supposing that three target frequencies are necessary, a microphone array is comprised of 7 microphones M₁ through M₇ and three microphone sub-arrays. In particular, the microphones M₁, M₄, and M₇ constitute a first microphone sub-array, the microphones M₂, M₄, and M₆ constitute a second microphone sub-array, and the microphones M₃, M₄, and M₅ constitute a third microphone sub-array. The first through third microphone sub-arrays are respectively arranged at optimised locations obtained using Equation (1) so that they can respectively serve a low frequency range, an intermediate frequency range, and a high frequency range provided by frequency channels of an acoustic model. As the number of frequency channels of the acoustic model increases, the distance between adjacent microphones becomes smaller.

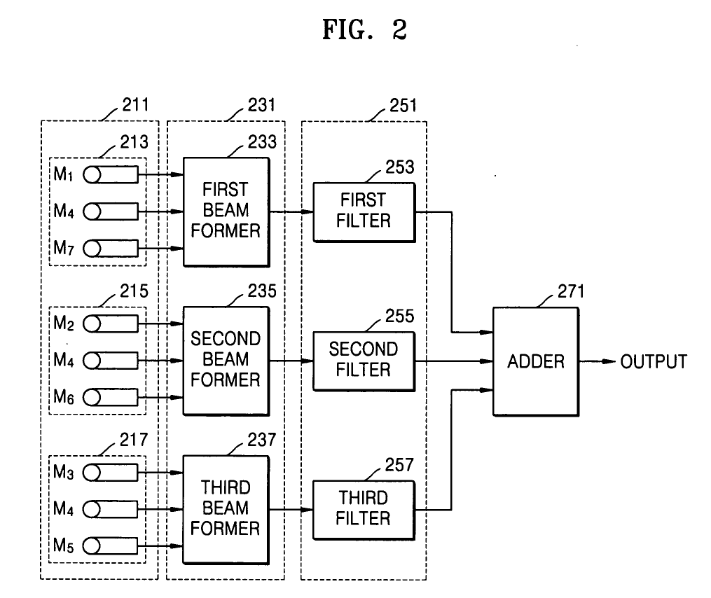

FIG. 2 is a block diagram of a beam forming apparatus using a microphone array according to a first embodiment of the present invention. Referring to FIG. 2, the beam forming apparatus includes a microphone array 211 comprised of three microphone sub-arrays 213, 215, and 217, a beam formation unit 231 comprised of first through third beam formers 233, 235, and 237 forming beams in response to signals output from the microphone sub-arrays 213, 215, and 217, respectively, a filtering unit 251 comprised of first through third filters 253, 255, and 257 performing filtering on signals output from the first through third beam formers 233, 235, and 237, respectively, and an adder 271 adding signals output from the first through third filters 253, 255, and 257. For the convenience of explanation, an acoustic model is supposed to have three target frequencies, i.e., first through third target frequencies f₁ through f₃ respectively selected from a low frequency range, an intermediate frequency range, and a high frequency range, and thus the microphone array 211 is illustrated in FIG. 2 having 7 microphones and three microphone sub-arrays.

Referring to FIG. 2, the microphone array 211 has a geometrical structure where the microphone sub-arrays 213, 215, and 217 correspond to first through third target frequencies f₁ through f₃, respectively, and their outputs are input into their corresponding beam formers 233, 235, and 237.

In the beam formation unit 231, the first beam former 233 delays voice signals output from microphones M₁, M₄, and M₇ of the first microphone sub-array 213 for a predetermined amount of time and adds the delayed voice signals, thus generating a beam. The second beam former 235 delays voice signals output from microphones M₂, M₄, and M₆ of the second microphone sub-array 215 for a predetermined amount of time and adds the delayed voice signals, thus generating a beam. The third beam former 237 delays voice signals output from microphones M₃, M₄, and M₅ of the third microphone sub-array 217 for a predetermined amount of time and adds the delayed voice signals, thus generating a beam. The first through third beam formers 233, 235, and 237 may adopt a delay-and-sum beam forming method to generate beams. The delay and sum beam forming method is as follows. Each of the first through third beam formers 233, 235, and 237 receives voice signals from its corresponding microphones. Then, each of the first through third beam formers 233, 235, and 237 figures out correlation among its input voice signals and calculates the amount of time for which the input signals are about to be delayed based upon the correlation between the input signals. Thereafter, each of the first through third beam formers 233, 235, and 237 delays its input signals by as much as the calculated amount of time and outputs the results of the delaying. Here, the calculation of the delay time can be performed in various ways other than the method set forth herein, i.e., the calculation method taking advantage of the correlation between the input signals of each of the first through third beam formers 233, 235, and 237. The outputs of the first through third beam formers 233, 235, and 237 are provided to the first through third filters 253, 255, and 257, respectively.

In the filtering unit 251, the first filter 253 performs low pass filtering on the output of the first beam former 233. Particularly, the first filter 253 filters a signal having a frequency lower than the first target frequency f₁ in a low frequency range out of the output of the first beam former 233 and then outputs the result of the filtering. The second filter 255 performs band pass filtering on the output of the second beam former 235. Particularly, the second filter 255 filters a signal having a frequency in a range between the first target frequency f₁ and the second target frequency f₂, out of the output of the second beam former 235 and then outputs the result of the filtering. The third filter 257 performs high pass filtering on the output of the third beam former 237. Particularly, the third filter 257 filters a signal having a frequency higher than the second target frequency f₂ out of the output of the third beam former 237 and then outputs the result of the filtering. In a case where an acoustic model has i frequency channels, the filtering unit 251 is comprised of i filters. Among the i filters, a first filter, and second to (i−1)-th filters, and an i-th filter perform low pass filtering, band pass filtering, and high pass filtering, respectively. The cut-off frequency of each of the filters is determined depending on the target frequency given by each of the frequency channels.

The adder 271 adds signals output from the filtering unit 251 and then inputs the result of the adding into a voice recognizer (not shown).

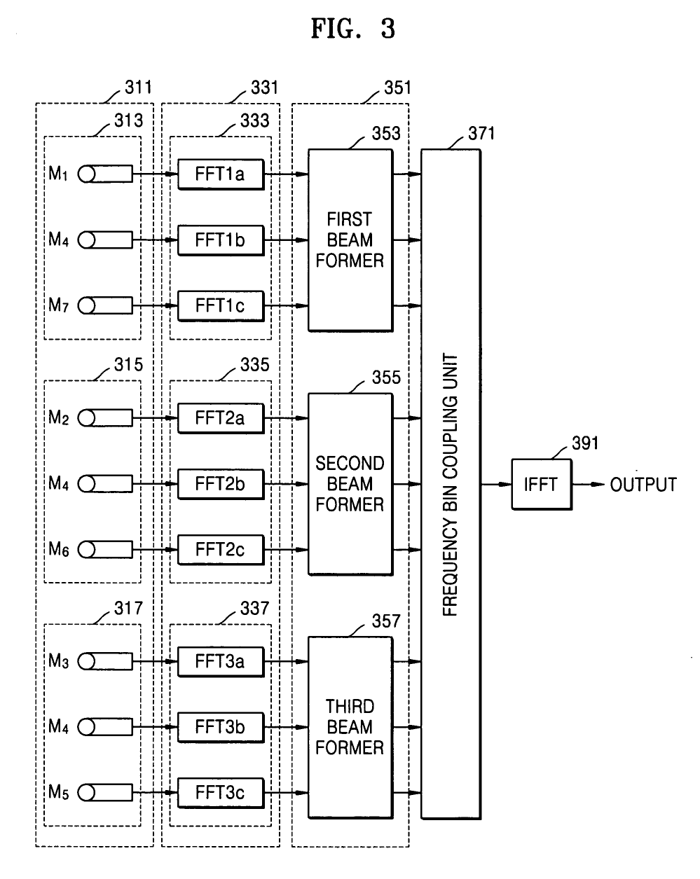

FIG. 3 is a block diagram of a beam forming apparatus using a microphone array according to a second embodiment of the present invention. The beam forming apparatus includes a microphone array 311 comprised of three microphone sub-arrays 313, 315, and 317, a time/frequency conversion unit 331 comprised of first through third high-speed Fourier transform units 333, 335, and 337, a beam formation unit 351 comprised of first through third beam formers 353, 355, and 357, a frequency bin coupling unit 371, and a frequency/time conversion unit 391. Here, each of the first through third high-speed Fourier transform units 333, 335, and 337 is comprised of high-speed Fourier transformers respectively corresponding to microphones constituting the microphone array 311. In the beam forming apparatus shown in FIG. 3, like in the case of the beam forming apparatus shown in FIG. 2, an acoustic model is supposed to provide three target frequencies, i.e., first through third target frequencies f₁ through f₃, respectively selected from a low frequency range, an intermediate frequency range, and a high frequency range. Accordingly, in FIG. 3, the beam forming apparatus including 7 microphones and three microphone sub-arrays is shown as an embodiment of the present invention.

Referring to FIG. 3, the microphone array 311 has a geometrical structure where the microphone sub-arrays 313, 315, and 317 correspond to first through third target frequencies f₁ through f₃, respectively, and outputs of microphones M₁ through M₇ are input into their corresponding high-speed Fourier transformers FFT1a through FFT3c.

In the time/frequency conversion unit 331, the high-speed Fourier transformers FFT1a through FFT1c of the first high-speed Fourier transform unit 333 convert time-domain voice signals output from microphones M₁, M₄, and M₇, respectively, of the first microphone sub-array 313 into frequency-domain voice signals by performing high-speed Fourier transform on the time-domain voice signals. Thereafter, each of the high-speed Fourier transformers FFT1a through FFT1c extracts a first frequency bin, which is a frequency value corresponding to the first target frequency f₁, from its corresponding frequency-domain voice signal and then transmits the first frequency bin to the first beam former 353. The high-speed Fourier transformers FFT2a through FFT2c of the second high-speed Fourier transform unit 335 convert time-domain voice signals output from microphones M₂, M₄, and M₆, respectively, of the second microphone sub-array 315 into frequency-domain voice signals by performing high-speed Fourier transform on the time-domain voice signals. Thereafter, each of the high-speed Fourier transformers FFT2a through FFT2c extracts a second frequency bin, which is a frequency value corresponding to the second target frequency f₂, from its corresponding frequency-domain voice signal and then transmits the second frequency bin to the second beam former 355. The high-speed Fourier transformers FFT3a through FFT3c of the third high-speed Fourier transform unit 337 convert time-domain voice signals output from microphones M₃, M₄, and M₅, respectively, of the third microphone sub-array 317 into frequency-domain voice signals by performing high-speed Fourier transform on the time-domain voice signals. Thereafter, each of the high-speed Fourier transformers FFT3a through FFT3c extracts a third frequency bin, which is a frequency value corresponding to the third target frequency f₃, from its corresponding frequency-domain voice signal and then transmits the third frequency bin to the third beam former 357. Here, each of the high-speed Fourier transformers FFT1a through FFT3c extracts only one frequency bin corresponding to its corresponding target frequency. However, each of the high-speed Fourier transformers FFT1a through FFT3c may extract two or more target frequencies and then provide them to the beam formation unit 351.

In the beam formation unit 351, the first beam former 353 generates a beam using voice signals including the first frequency bins respectively provided by the high-speed Fourier transformers FFT1a through FFT1c. The second beam former 355 generates a beam using voice signals including the second frequency bins respectively provided by the high-speed Fourier transformers FFT2a through FFT2c. The third beam former 357 generates a beam using voice signals including the third frequency bins respectively provided by the high-speed Fourier transformers FFT3a through FFT3c. Here, each of the first through third beam formers 353, 355, and 357 is comprised of a single beam former. However, each of the first through third beam formers 353, 355, and 357 may be comprised of a plurality of beam formers, and the number of beam formers constituting each of the first through third beam formers 353, 355, and 357 may vary depending on the number of frequencies bins extracted by the first through third high-speed Fourier transform units 333, 335, and 337. For example, in a case where the first high-speed Fourier transform unit 333 extracts three frequency bins corresponding to three target frequencies, the first beam former 353 is comprised of three beam formers respectively corresponding to the three frequency bins. The first through third beam formers 353, 355, and 357, like their counterparts in the first embodiment, may adopt a delay-and-sum beam forming method or a beam forming method taking advantage of minimum variance. In a minimum variance technique that can be applied to the first through third beam formers 353, 355, and 357, different weights are chosen for voice signals input from microphones depending on the incident angles of the input voice signals, thus enhancing a signal-to-noise ratio. An optimization for obtaining weighted vectors in the minimum variance technique can be derived from a beam forming technique having the linear constraint, as shown in Equation (2) below.

min_{w}w^{H}\hat{R}w, subject to w^{H}α(θ)=1 (2)

A weighted vector [w={w₁(k), w₄(k), w₇(k)}] corresponding to the first frequency bin [xₐ(k)={x₁(k), x₄(k), x₇(k)}] provided to the first beam former 353 by the high-speed Fourier transformers FFT1a through FFT1c can be expressed by Equation (3). Here, k can be expressed by (fₖ/fₛ) multiplied by the number of FFT points, fₖ represents an k-th target frequency, and fₛ represents a sampling frequency used in conversion of an analog signal output from a microphone into a digital signal to be provided to a high-speed Fourier transformer.

$$w = \frac{{\hat{R}}^{- 1} a ( θ )}{{a}^{H} ( θ ) {\hat{R}}^{- 1} a ( θ )} \qquad ( 3 )$$

In Equations (2) and (3), \hat{R} represents a covariance matrix of the output of the high-speed Fourier transformer 333, a(θ)=[{a₁(θ), a₄(θ), a₇(θ)}] represents a steering vector, and θ represents a look direction. The minimum variance technique and a method of obtaining the steering vector a(θ) have been disclosed in great detail in a paper entitled “Speech Enhancement Based on the Subspace Method” written by Futoshi et al. (IEEE Transaction on Speech and Audio Processing, Vol. 8, No. 5, September 2000).

The first beam former 353 generates a beam by multiplying the three first frequency bins by a weighted value obtained using Equation (3) and then adding the results of the multiplication. In the same manner, the second and third beam formers 355 and 357 each generate a beam.

The frequency bin coupling unit 371 couples beams of the first through third frequency bins generated by the first through third beam formers 353, 355, and 357 and then provides the result of the coupling to the frequency/time conversion unit 391.

The frequency/time conversion unit 391 converts a frequency-domain voice signal provided by the frequency bin coupling unit 371 into a time-domain voice signal by performing inverse high-speed Fourier transform on the frequency-domain voice signal and then outputs the time-domain voice signal.

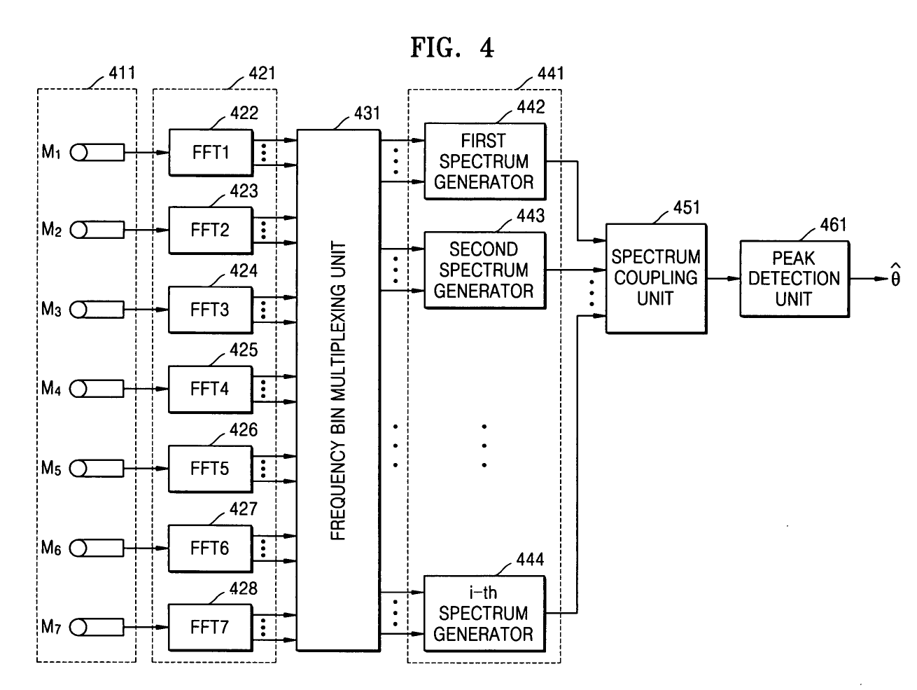

FIG. 4 is a block diagram of an apparatus for estimating an acoustic source direction using a microphone array according to a preferred embodiment of the present invention. Referring to FIG. 4, the apparatus for estimating an acoustic source direction includes a microphone array 411 comprised of 7 microphones M₁ through M₇, a high-speed Fourier transform unit 421 comprised of first through seventh high-speed Fourier transformers FFT1 through FFT7 (422 through 428), a frequency bin multiplexing unit 431, a spectrum generation unit 441 comprised of first through i-th spectrum generators 442, 443, and 444, a spectrum coupling unit 451, and a peak detection unit 461. Here, the frequency bin multiplexing unit 431, the spectrum generation unit 441, the spectrum coupling unit 451, and the peak detection unit 461 constitute an acoustic source direction detection device. For the convenience of explanation, the microphone array 411 is illustrated in FIG. 4 and will be described in the following paragraphs as having seven microphones and three microphone sub-arrays. However, the present invention is not limited to the numbers of microphone sub-arrays and of microphones set forth herein. Rather, the present invention can be applied to other microphone array structures including i microphone sub-arrays and 2i+1 microphones.

Referring to FIG. 4, the microphone array 411 has a geometric structure that it can deal with target frequencies f₁ through f₃, and voice signals output from the microphones M₁ through M₇ are provided to the high-speed Fourier transformers FFT1 through FFT7 (422 through 428), respectively.

The high-speed Fourier transform unit 421 converts time-domain voice signals output from the microphones M₁ through M₇ into frequency-domain voice signals by performing high-speed Fourier transform on the time-domain voice signals.

The frequency bin multiplexing unit 431 extracts first through i-th frequency bins corresponding to first through i-th target frequencies, respectively, from each of the frequency-domain voice signals provided by the first through seventh high-speed Fourier transformers FFT1 through FFT7 (422 through 428). Thereafter, the frequency bin multiplexing unit 431 provides a first multiplexing signal comprised of seven first frequency bins f_{b1}, a second multiplexing signal comprised of seven second frequency bins f_{b2}, and a third multiplexing signal comprised of seven i-th frequency bins f_{bi} to the first spectrum generator 442, the second spectrum generator 443, and the i-th spectrum generator 444, respectively.

In the spectrum generation unit 441, the first through i-th spectrum generators 442, 443, and 444 generate spatial spectra for the first through i-th frequency bins, respectively. In a case where the first through i-th spectrum generators 442, 443, and 444 adopt a multiple signal classification (MUSIC) algorithm, a MUSIC spatial spectrum for an i-th frequency bin can be represented by Equation (4) below.

$$P ( θ , {f}_{i} ) = \frac{{a}^{H} ( θ , {f}_{i} ) a ( θ , {f}_{i} )}{{a}^{H} ( θ , {f}_{i} ) V ( {f}_{i} ) {V}^{H} ( {f}_{i} ) a ( θ , {f}_{i} )} \qquad ( 4 )$$

In Equation (4), V(fᵢ) represents a matrix of an eigenvector corresponding to noise subspace of a covariance matrix for an i-th frequency bin, and α(θ,fᵢ) represents a steering vector corresponding to the i-th frequency bin. The MUSIC algorithm has been disclosed in great detail in Japanese Patent Publication No. 2001-337694.

The spectrum coupling unit 451 couples the spatial spectra for the first through i-th frequency bins provided by the first through i-th spectrum generators 442, 443, and 444, respectively, and then provides the result of the coupling, i.e., a general spatial spectrum, to the peak detection unit 461.

The peak detection unit 461 detects a peak power over all frequency ranges based on the spatial spectrum provided by the spectrum coupling unit 451 and estimates an acoustic source direction \hat{θ} based on a direction, that is, a θ value corresponding to the peak power.

### EXPERIMENTAL EXAMPLE

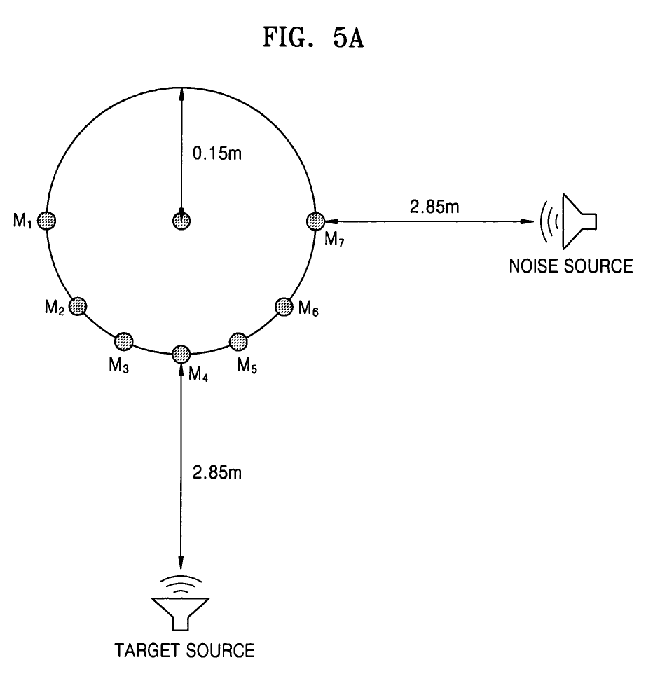

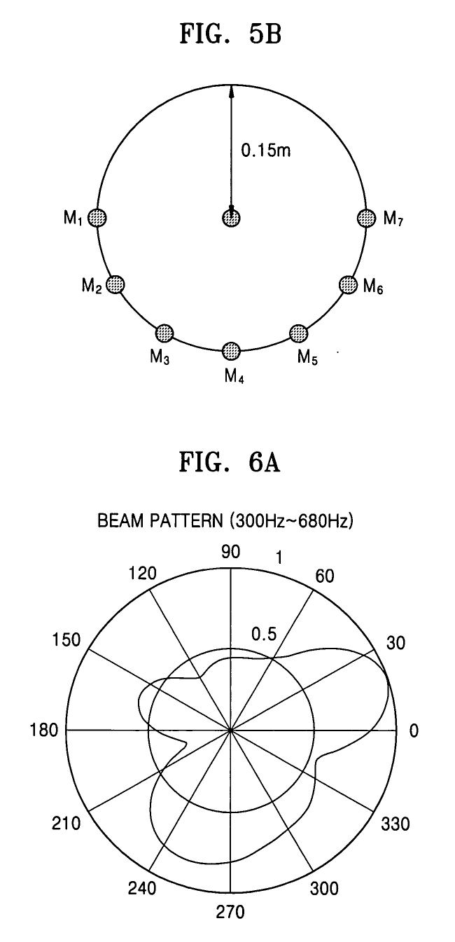

An experiment was carried out to compare the performance of a beam forming method according to the present invention with the performance of a conventional beam forming method. For the experiment, a microphone array according to the present invention, like the one shown in FIG. 5A, and a conventional microphone array, like the one shown in FIG. 5B were used. Let us assume that a distance between the center of each of those microphone arrays used in the experiment and a target source was 3 m and a real look direction was 0°. Suppose the sound source localization apparatus used in this experiment estimated a look direction as 10° which is the case of a look direction error. A distance between the center of each of those microphone arrays used in the experiment and a noise source was 3 m, and a look direction was 90°. Here, the beam forming apparatus was supposed to have no information on the precise location of the noise source. Fan noise was used as the noise source. Each of those microphone arrays used in the experiment included 7 microphones and three sub-arrays respectively optimised for three target frequencies. The three target frequencies were respectively set at 680 Hz, 1.3 KHz, and 2.7 KHz. In the experiment, an embedded voice recognizer was used, 50 isolated words were tested, and the beam forming apparatus adopted a minimum variance technique. The voice recognizer used a Hidden Markov Model (HMM) acoustic model including eight Gaussian mixture probability density functions, three states, and 255 models and a database storing 20,000 speech data made by 100 people. Voice feature parameters used in the experiment include a 12-dimensional static mel-frequency cepstral coefficient (MFCC), 12-dimensional delta MFCC, one-dimensional delta energy, and cepstral mean subtraction.

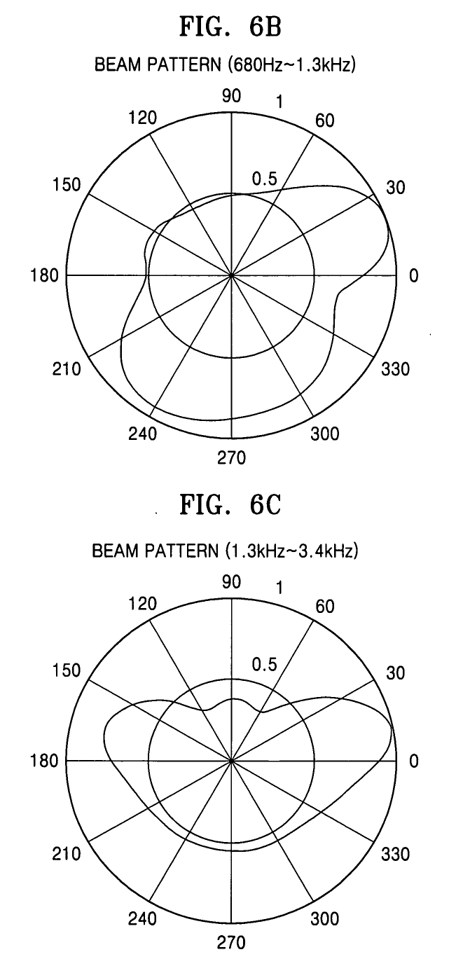

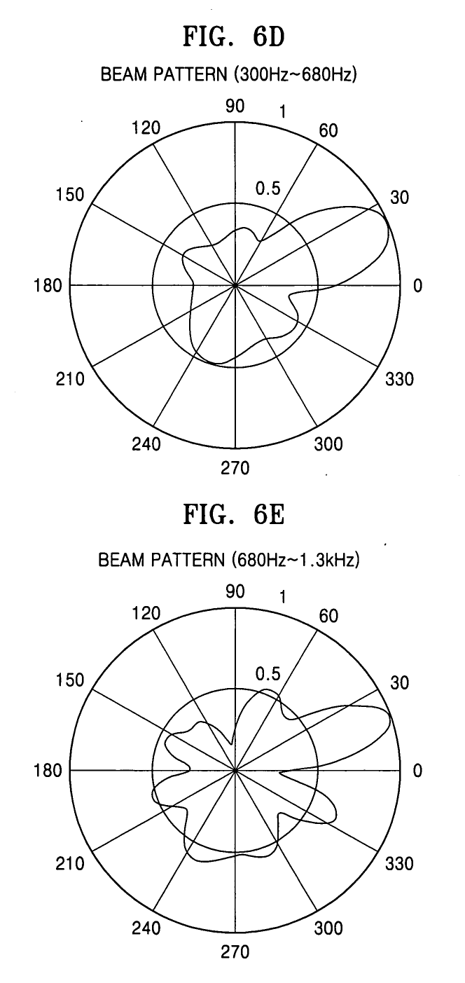

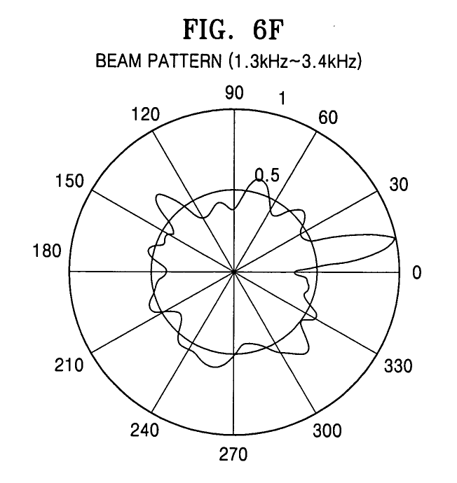

Beam patterns generated under the above-described experiment conditions are shown in FIGS. 6A through 6F. In particular, FIGS. 6A through 6C show beam patterns in frequency ranges of 300-680 Hz, 680 Hz-1.3 KHz, and 1.3 KHz-3.4 KHz, respectively. The beam patterns are obtained by applying a beam forming method using a microphone array according to the present invention to a circumstance where a look direction error is 10°. FIGS. 6D through 6F show another beam patterns in frequency ranges of 300-680 Hz, 680 Hz-1.3 KHz, and 1.3 KHz-3.4 KHz, respectively. The beam patterns are obtained by using a beam forming method using a conventional microphone array. Referring to FIGS. 6A through 6F, the beam forming method using a microphone array according to the present invention can provide beam patterns having constant directivity in each of the frequency ranges, i.e., 300-680 Hz, 680 Hz-1.3 KHz, and 1.3 KHz-3.4 KHz.

Voice recognition rates obtained using a voice recognizer adopting a beam forming method according to the present invention are compared to voice recognition rates obtained using a voice recognizer adopting conventional beam forming method in Table 1 below.

TABLE 1

| | Look direction error (°) | | | | |
|---|---|---|---|---|---|
| | 0 | 5 | 10 | 15 | 20 |
| Voice recognition rate (%) of the | 82.5 | 82.5 | 80 | 72.5 | 77.5 |
| present invention | | | | | |
| Decrease rate (%) | — | 0 | 2.5 | 7.5 | −5 |
| Voice recognition rate (%) of the | 82.5 | 65 | 47.5 | 45 | 40 |
| prior art | | | | | |
| Decrease rate (%) | — | 17.5 | 17.5 | 2.5 | 5 |

The look direction error in table 1 is a look direction error of a beam forming apparatus adopting a minimum variance technique. Referring to Table 1, the beam forming method using a microphone array according to the present invention shows very excellent voice recognition performance despite a look direction error.

The present invention can be embodied in the form of a device or as computer-readable program codes recorded on a computer-readable recording medium, which are capable of enabling the above-described functions of the present invention with the help of a central processing unit and memories. The computer-readable recording medium includes all kinds of recording devices where computer-readable data can be recorded. For example, the computer-readable recording medium includes a ROM, a RAM, a CD-ROM, a magnetic tape, a floppy disk, an optical data storage, and a carrier wave, such as data transmission through the Internet. In addition, the computer-readable recording medium can be decentralized over computer systems connected via network, and computer-readable codes can be stored in the computer-readable recording medium and can be executed in a decentralized manner.

Functional programs, codes, and code segments enabling the present invention can be easily deduced by programmers in the field pertaining to the present invention.

As described above, according to the present invention, the width of a main lobe is regular in any frequency range, and thus the probability of signals being distorted due to variations in frequency decreases. Accordingly, it is possible to generate beams having constant directivity. In addition, according to the present invention, it is possible to obtain robust target signals even when an error occurs during estimation of a target source direction. Thus, it is possible to enhance a voice recognition rate.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A microphone array comprising:
first through n-th microphone sub-arrays,
wherein each of the microphone sub-arrays comprises:
a first microphone placed at a predetermined location on a flat plate, which commonly belongs to each of the microphone sub-arrays; and
second and third microphones placed at locations perpendicularly spaced by a predetermined segment from a straight line connecting the first microphone and the center of the flat plate, the predetermined segment being determined depending on a target frequency allotted to reach of the microphone sub-arrays.

2. The microphone array of claim 1, wherein the predetermined segment dᵢ can be obtained using the following equation:
$${d}_{i} = \frac{c}{2 {f}_{i}}$$
$$( i = 1 , … , n )$$
where c indicates the velocity of sound in the air, and fᵢ indicates the target frequency allotted to each of the microphone sub-arrays.

3. An apparatus for forming constant directivity beams comprising:
a microphone array, which is comprised of first through n-th microphone sub-arrays,
wherein each of the microphone sub-arrays comprises:
a first microphone placed at a predetermined location on a flat plate, which commonly belongs to each of the microphone sub-arrays; and
second and third microphones placed at locations perpendicularly spaced by a predetermined segment from a straight line connecting the first microphone and the center of the flat plate, the predetermined segment being determined depending on a target frequency allotted to reach of the microphone sub-arrays.

4. The beam forming apparatus of claim 3 further comprising:
a beam formation unit receiving voice signals output from the first through n-th microphone sub-arrays and generating a beam for each of the first through n-th microphone sub-arrays;
a filtering unit filtering the beams output from the beam formation unit; and
an adding unit adding the filtered signals output from the filtering unit.

5. The beam forming apparatus of claim 4, wherein the filtering unit comprises:
a low pass filter filtering a signal having a frequency lower than the first target frequency out of the beam generated for the first microphone sub-array;
n−2 band pass filters filtering signals in a frequency range between two adjacent target frequencies among the second through (n−1)-th target frequencies out of the beams generated for the second through (n−1)-th microphone sub-arrays; and
a high pass filter filtering a signal having a frequency higher than the (n−1)-th target frequency out of the beam generated for the n-th microphone sub-array.

6. The beam forming apparatus of claim 3 further comprising:
a time/frequency conversion unit converting voice signals output from the microphones of each of the first through n-th microphone sub-arrays into frequency-domain voice signals by performing high-speed Fourier transform on the voice signals and extracting first through n-th frequency bins corresponding to the first through n-th microphone sub-arrays, respectively;
a beam formation unit receiving the first through n-th frequency bins provided by the time/frequency conversion unit and then generating beams;
a frequency bin coupling unit coupling the first through n-th frequency bins provided by the beam formation unit; and
a frequency/time conversion unit converting the result of the coupling into a time-domain beam by performing inverse high-speed Fourier transform on the output of the frequency bin coupling unit.

7. The beam forming apparatus of claim 3, wherein the predetermined segment dᵢ can be obtained using the following equation:
$${d}_{i} = \frac{c}{2 {f}_{i}}$$
$$( i = 1 , … , n )$$
where c indicates the velocity of sound in the air, and fᵢ indicates the target frequency allotted to each of the microphone sub-arrays.

8. A method of forming constant directivity beams comprising:
(a) placing a microphone array, which is comprised of first through n-th microphone sub-arrays,
wherein each of the microphone sub-arrays comprises:
a first microphone placed at a predetermined location on a flat plate, which commonly belongs to each of the microphone sub-arrays; and
second and third microphones placed at locations perpendicularly spaced by a predetermined segment from a straight line connecting the first microphone and the center of the flat plate, the predetermined segment being determined depending on a target frequency allotted to reach of the microphone sub-arrays.

9. The beam forming method of claim 8 further comprising:
(b) forming a beam for each of the first through n-th microphone sub-arrays by receiving voice signals output from the first through n-th microphone sub-arrays;
(c) performing one of low pass filtering, band pass filtering, and high pass filtering on the beams generated in step (b) depending on their corresponding target frequencies; and
(d) adding the results of the filtering performed in step (c).

10. The beam forming method of claim 8 further comprising:
(b) converting voice signals output from the microphones of each of the first through n-th microphone sub-arrays into frequency-domain voice signals by performing high-speed Fourier transform on the voice signals and extracting first through n-th frequency bins corresponding to the first through n-th microphone sub-arrays, respectively;
(c) receiving the first through n-th frequency bins extracted in step (b) and then generating beams;
(d) coupling the beams of the first through n-th frequency bins; and
(e) converting the beam output in step (d) into a time-domain beam by performing inverse high-speed Fourier transform.

11. An apparatus for estimating an acoustic source direction, comprising a microphone array, which is comprised of first through n-th microphone sub-arrays,
wherein each of the microphone sub-arrays comprises:
a first microphone placed at a predetermined location on a flat plate, which commonly belongs to each of the microphone sub-arrays; and
second and third microphones placed at locations perpendicularly spaced by a predetermined segment from a straight line connecting the first microphone and the center of the flat plate, the predetermined segment being determined depending on a target frequency allotted to reach of the microphone sub-arrays.

12. The apparatus of claim 11 further comprising:
a high-speed Fourier transform unit converting voice signals output from (2n+1) microphones into frequency-domain voice signals by performing high-speed Fourier transform on the voice signals; and
an acoustic source direction detection means detecting a peak value over all frequency ranges in a spatial spectrum provided for each frequency bin of each of the frequency-domain voice signals provided by the high-speed Fourier transform unit and then determining a direction corresponding to the detected peak value as an estimated acoustic source direction.

13. The apparatus of claim 11, wherein the predetermined segment dᵢ can be obtained using the following equation:
$${d}_{i} = \frac{c}{2 {f}_{i}}$$
$$( i = 1 , … , n )$$
where c indicates the velocity of sound in the air, and fᵢ indicates the target frequency allotted to each of the microphone sub-arrays.

14. The apparatus of claim 12, wherein the acoustic source direction detection means comprises:
a frequency bin multiplexing unit multiplexing the frequency-domain voice signals provided by the high-speed Fourier transform unit on a frequency bin basis;
a spectrum generation unit generating spatial spectra for first through k-th frequency bins provided by the frequency bin multiplexing unit;
a spectrum coupling unit coupling the spatial spectra for the first through k-th frequency bins; and
a peak detection unit detecting a peak value in a spatial spectrum provided by the spectrum coupling unit over all frequency ranges and determining a direction corresponding to the detected peak value as an estimated acoustic source direction.

15. A method for estimating an acoustic source direction comprising:
(a) placing a microphone array, which is comprised of first through n-th microphone sub-arrays,
wherein each of the microphone sub-arrays comprises:
a first microphone placed at a predetermined location on a flat plate, which commonly belongs to each of the microphone sub-arrays; and
second and third microphones placed at locations perpendicularly spaced by a predetermined segment from a straight line connecting the first microphone and the center of the flat plate, the predetermined segment being determined depending on a target frequency allotted to reach of the microphone sub-arrays.

16. The apparatus of claim 15, wherein the predetermined segment dᵢ can be obtained using the following equation:
$${d}_{i} = \frac{c}{2 {f}_{i}}$$
$$( i = 1 , … , n )$$
where c indicates the velocity of sound in the air, and fᵢ indicates the target frequency allotted to each of the microphone sub-arrays.

17. The method of claim 15 further comprising:
(b) converting voice signals output from (2n+1) microphones into frequency-domain voice signals by performing high-speed Fourier transform on the voice signals; and
(c) detecting a peak value over all frequency ranges in a spatial spectrum provided for each frequency bin of each of the frequency-domain voice signals obtained in step (b) and then determining a direction corresponding to the detected peak value as an estimated acoustic source direction.

18. The method of claim 17, wherein step (c) comprise:
(c1) multiplexing the frequency-domain voice signals obtained in step (b) on a frequency bin basis;
(c2) generating spatial spectra for first through k-th frequency bins that are the results of the multiplexing performed in step (c1);
(c3) coupling the spatial spectra for the first through k-th frequency bins; and
(c4) detecting a peak value in a spatial spectrum obtained as a result of the coupling performed in step (c3) coupling unit over all frequency ranges and determining a direction corresponding to the detected peak value as an estimated acoustic source direction.

19. The method of claim 8, further comprising a computer-readable recording medium having recorded thereon a computer readable program code to form constant directivity beams using the microphone array.

20. The method of claim 15, further comprising a computer-readable recording medium having recorded thereon a computer readable program code to estimate an acoustic source direction using the microphone array.
